(19) United States
(12) Patent Application Publication
(10) Pub. No.: US 2007/0039540 A1
(43) Pub. Date: Feb. 22, 2007

(54) Bookmark for books with a spine binding

(76) Inventor: Steven F. Streiff, Phoenix, AZ (US)

Correspondence Address: Loen Patent Services, Suite 224, 2266 S Dobson Road, Mesa, AZ, 85202, US

(21) Appl. No.: 11/204,273

(22) Filed: Aug. 16, 2005

(51) Int. Cl. B42D 9/00

(52) U.S. Cl. 116/234

(57) ABSTRACT

A bookmark is disclosed that is suitable for books with a spine binding method, such as a spiral bound log book. The bookmark consists of an elongated marking area, such as a rectangle, and an attached insertion area that is inserted into the spiral binding. The bookmark may have a large surface that would allow printing of advertisements or other important communication on the bookmark.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO SEQUENCE LISTING, A TABLE, OR COMPUTER PROGRAM LISTING COMPACT DISC APPENDIX

Not applicable.

### BACKGROUND OF THE INVENTION

1. Field of the Invention

The present invention is a bookmark specifically designed for books with a spine binding method, such as spiral bound book. It is especially suited for use in a log book where multiple people are opening and closing the same book frequently.

2. Discussion of Similar Art

Since the advent of the printing press, bookmarks of various sorts have been common for many years. A bookmark is a thin marker or book insert, made from a suitably thin material, such as paper or cardboard, and is placed by a reader inside the book so that it is easy to return to the same book page in the future. It is normally designed to avoid any damage to the book. Some of the earliest known bookmarks date from the end of the sixteenth century, and Queen Elizabeth I is known to have used one.

Existing bookmarks have limitations, especially when used in the workplace. When multiple people handle the same book, such as a log book, a simple elongated rectangular bookmark is likely to fall out of the book, requiring an employee to make the effort to correctly relocate the log page and reinsert the bookmark. Without a convenient design that reasonably assures that the bookmark will remain in log book, employees find themselves frustrated with the frequent effort this requires, and are likely to abandon the bookmark altogether. Without a bookmark, it is very easy to begin writing on the wrong page which complicates communication between employees on what should be noted and remembered.

U.S. Pat. No. 6,722,309, for example, describes a bookmark that has been adapted for insertion of an elongated marker into a book and then has a hook feature for anchoring the marker on the outside of the book binding. This bookmark has an important limitation for a spiral bound book. The hook portion of the described bookmark has an unsuitable width that is designed to be outside of the book binding. When a spiral bound workbook is laid open, the width of the hook portion will cause the bookmark to lift, rotate, or fall out of the book. Consequently, the employees will remove the bookmark, rather than leave it in the book. This increases the likelihood that the bookmark will be lost or reinserted in the wrong place. If the bookmark remains in the spiral bound book, the book will not lay flat on the writing table which makes it difficult to write legibly everywhere on the page.

Other bookmarks, as described in U.S. Pat. No. 5,375,884 and U.S. Pat. No. 5,095,846, have similar objections because the attaching portion to the book is exterior to the book binding.

### BRIEF SUMMARY OF THE INVENTION

It is therefore the objective to design a bookmark that is suitable for a spiral bound workbook, such as a log book, with improved convenience and design. It is also the object of this invention to provide for advertising or other important communication on the bookmark.

### BRIEF DESCRIPTION OF THE SEVERAL VIEWS OF THE DRAWING

FIG. 1 shows an overall view of the bookmark and highlights the additional communication uses of the bookmark.

FIG. 2 shows the important design features of the bookmark's outline.

FIG. 3 shows how the bookmark is inserted into the workbook binding.

### DETAILED DESCRIPTION OF THE INVENTION

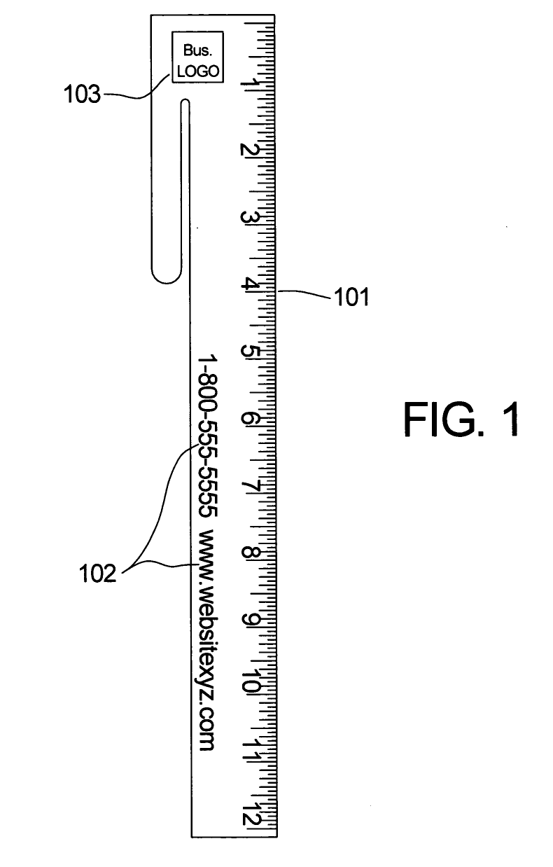

FIG. 1 shows an overall view of a bookmark, suitable for use with a spine bound log book. Ruler markings 101 are printed on the surface of the bookmark along one edge. Advertising or reminder information, such as a phone number or web site address 102, is printed on an available portion of the bookmark. A business logo 103 may also be printed on the bookmark, correctly oriented to the reader when the bookmark is used.

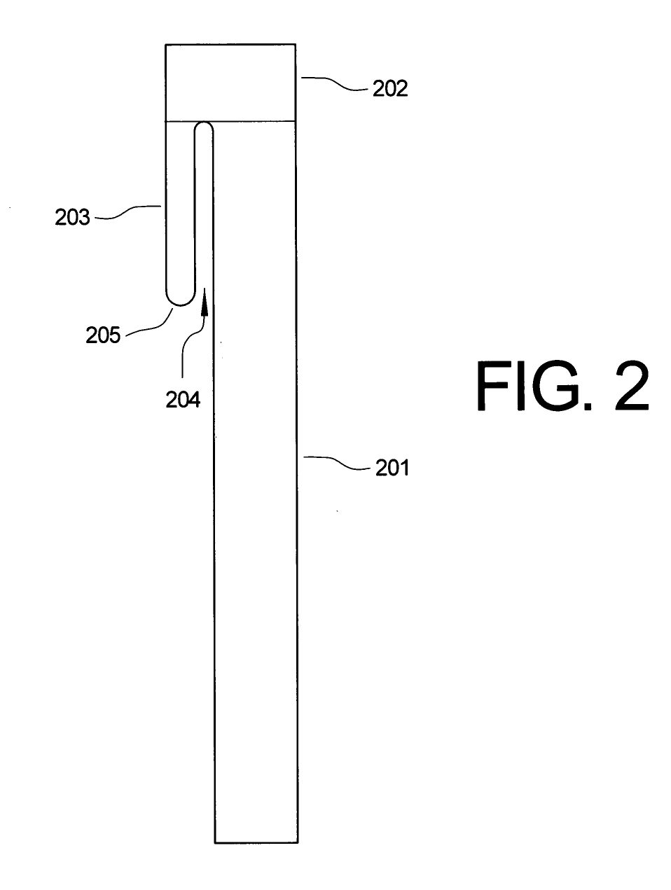

FIG. 2 shows the main features on an outline of the bookmark. An elongated marking area 201 is adjacent aligned to a narrow inserting member 203 that is to be inserted inside the spine binding. The narrow inserting member 203 is attached to the elongated marking area 201 by a wide joining area 202 of the bookmark. The gap 204 between the elongated marking area 201 and the narrow inserting member 203 is just wider than the thickness of the spine binding material. The spine binding material is often wire or plastic. The free end 205 of the narrow inserting member 203 may be rounded so that it will not catch on the spine binding material when inserted. All portions of the bookmark are made from the same material with a common thickness.

The term adjacently aligned should be understood as two elongated areas that are in the same plane, are oriented to the same elongated direction, are located in a side by side arrangement as shown in FIG. 2 rather than end to end, each have one end aligned to an alignment line that is perpendicular to their common elongated direction, and both areas are on the same side of the alignment line.

The term spine binding method should be understood as the method of loosely joining a sheaf of pages with a binding system that loops around or through sequential holes on one edge of the pages. The loops may be in a continual spiral or as separate, individual loops. The loops normally are curved in some manner and are made from portions of circles, rings, spirals, straight lines, and ellipses. For example, a multi ring binding system, such as the three ring binder, would be included. Other included examples would be comb binding, coil binding, wire binding, and spiral binding. The bookmark is useful for a wide variety of spine binding methods, and does not depend upon how the loops are shaped, provided that there is a suitable opening for the narrow elongated member 203 to be inserted into the loops of the binding system.

The elongated marking area 201 may have a variety of shapes. A rectangular shape is preferred. However, novel shapes may also be employed with equal effectiveness. It may be desirable, for example, to use an elongated ellipse on one edge. However, it is preferred that the marking area be elongated, to allow easy opening of the book without awkwardness.

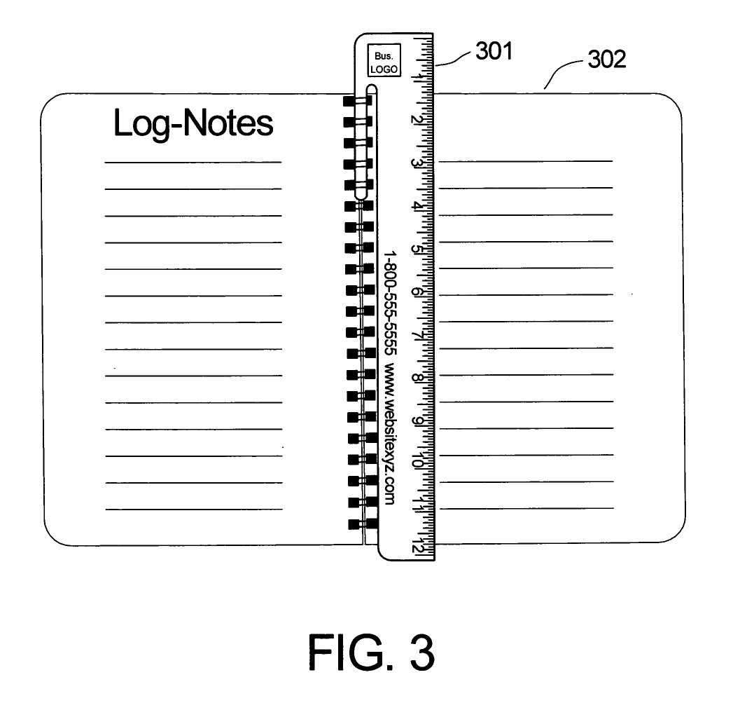

FIG. 3 shows how the bookmark 301 may be inserted into an open spiral bound logbook 302. The portion of the bookmark that is inserted into the binding may be tapered slightly for easy insertion into the binding.

The bookmark may be made out of a wide variety of materials. It is particularly economical and desirable to make it out of a common non-brittle plastic. However, various kinds of paper and cardboard may also be used satisfactorily. The thickness may vary somewhat, depending upon the service life and likelihood of page damage. For plastic, a thickness less than 1/16″ is less likely to damage pages, and a thickness between 0.03″-0.06″ will provide good economy.

While various embodiments of the present invention have been described, the invention may be modified and adapted to various uses to those skilled in the art. Therefore, this invention is not limited to the description and figures shown herein, and includes all such changes and modifications that are encompassed by the scope of the claims.

I claim:

1. A bookmark for a spine binding method book comprising:
a. a first elongated area and a second elongated area that are both oriented to the same elongated direction,
b. where said second elongated area is substantially the same width in said elongated direction,
c. where said first elongated area and said second elongated area are adjacently aligned,
d. an attaching area that is joined to the aligned end of said first elongated area and to the aligned end of said second elongated area,
e. where said first elongated area and said second elongated area are separated by a distance wider than the thickness of loops used in said spine binding method book,
f. where said second elongated area fits inside said loops used in said spine binding method book,
g. where said first elongated area, said second elongated area, and said attaching area are made from the same material.

2. The article according to claim 1 where the free end of said second elongated area has a rounded shape.

3. The article according to claim 1 where information is printed on any surface of said bookmark.

4. The article according to claim 1 where said material is a non-brittle plastic.

5. The article according to claim 1 where said first elongated area, said second elongated area, and said attaching area have a substantially uniform thickness.
